(19) United States
(12) Patent Application Publication
(10) Pub. No.: US 2006/0006257 A1
(43) Pub. Date: Jan. 12, 2006

(54) Method and apparatus for fragmentizing surface layer of concrete

(76) Inventor: Shin Narui, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/885,133

(22) Filed: Jul. 7, 2004

(51) Int. Cl. B02C 19/00

(52) U.S. Cl. 241/1

(57) ABSTRACT

A concrete surface layer fragmentizing method of fragmentizing a surface layer of a concrete structure by a jet formed by ejecting high pressure water from a nozzle. The method comprises adjusting control parameters for controlling the ejection and movement of the jet, including a fragmentation width, a standoff distance, ejection water pressure, ejection water amount, nozzle lateral movement speed, and the number of nozzle swing times; and sweeping the jet over a predetermined range so as to fragmentize only deteriorated concrete deteriorated in strength with leaving sound concrete (selective excavation).

### BACKGROUND OF THE INVENTION

1. Field of the Invention

The present invention relates to a method and apparatus for fragmentizing a surface layer of concrete using a jet formed by ejecting high pressure water.

2. Description of the Prior Art

In recent years, over-time deterioration of concrete structures has become a problem, and there has been an increasing demand for repair work which involves fragmentizing and removing deteriorated-to-an-advanced-degree portions of a concrete structure and placing repair concrete. FIG. 11a is a cross-sectional view of a deteriorated-to-an-advanced-degree concrete structure 1. The concrete structure 1, at its surface S, is in contact with an external environment such as air or sea water, and includes therein a reinforcing bar (rebar) 2a in a position at a depth Dᵣ.

Since concrete, even in a sound state, has a fine pore structure, a large number of capillary pores are exposed on the surface S. Meanwhile, those surrounding the concrete structure 1, such as acid rain, carbon dioxide, chloride ion (Cl⁻), and freezing/melting (through which water freezes and expands), are media for accelerating deterioration of concrete and reinforcing steel. When these media penetrate into concrete through pores and diffuse inside the concrete, chemical reactions proceed inside to gradually neutralize an alkaline concrete composition, resulting in reinforcing steel becoming likely to corrode. Moreover, when the chemical reaction with carbon dioxide further proceeds, the so-called carbonation (neutralization) occurs, where the hardening material composition of cement itself in the concrete is decomposed.

Referring to FIG. 11a, deteriorated concrete 1a with degraded strength due to such neutralization and carbonation is formed between the surface S and an interface B. Moreover, red rust 3 occurs around the rebar 2a to cause volume expansion (about 2.6 times), resulting in cracks 4 occurring in the concrete around the rebar 2a. The cracks 4 promote the penetration of the deterioration accelerating media, causing the deterioration to accelerate. When the cracks 4 further grow and become cracking on the surface, the integrity of concrete will be lost to allow a concrete fragment 1c to detach itself in the end.

However, the depth D_{B} of the deteriorated concrete 1a depends on environments and therefore varies with positions even in the same structure, making the interface B irregular as shown in the drawing. An exact depth of the deteriorated concrete 1a is difficult to tell.

Conventionally there is performed repair work wherein an area having the detachment of the fragment 1c or an area having a seeable crack where deterioration probably has occurred is fractured with a breaker, a drill or the like, as shown in FIG. 11b, thereby exposing reinforcing steel 2a, and wherein an anticorrosive material 7 is applied to the surface thereof, then repair concrete 5 is placed, and finally the surface S is coated with a concrete coating material 6.

Alternatively, deteriorated concrete 1a is fragmentized and removed by ejecting a high pressure water jet to the concrete surface thereby cutting the concrete composition and aggregates and digging to a given depth. FIG. 12 shows an example of such a conventional method. Having a nozzle rotating section 8, which rotates a plurality of nozzles 8a ejecting a high pressure water jet with directing them toward a to-be-fragmentized surface 1e, draw a circle and fragmentize while having the nozzle rotating section 8 moving laterally, the concrete surface layer is fragmentized in a strip equal in width to the diameter of the circle. Each nozzle 8a ejects an ultra high pressure small-amount water usually at an ejection water pressure of 200 to 250 MPa and at an ejection water amount of 20 to 25 liters per minute, thereby applying tremendous fragmentizing force. Hence, by the digging action of the jet, both unsound and sound concrete 1a and 1b are indiscriminately fragmentized from the surface. Also, the coarse aggregate is fragmentized likewise, thereby cutting it along the paths of the jet. Note that only the detachment of rust 3 occurs with falling short of cutting the steel bars 2a, 2b.

The method which uses a high pressure water jet for cutting, breaking, and cleaning is generally called a water jetting method (hereinafter, called WJ method), and the method using an ultra high pressure small-amount water jet like the above-described fragmentation may be particularly called a hydro-milling method (hereinafter, called HM method).

The above described conventional methods, however, have the following problems. First, it is difficult to fragmentize up to under the steel bars 2a without damaging the steel bars 2a with the conventional fragmentation method using a breaker, and thus, as shown in FIG. 11b, there remains deteriorated concrete 1a with cracks 4 under the steel bar 2a, thereby not being able to apply the anticorrosive material 7 to all around the steel bar 2a. Consequently, there is the problem that the deterioration further advances from such remaining parts into the inside (re-damage). Furthermore, even if all the deteriorated concrete 1a could be removed, new microcracks would occur on the surface, newly formed by fragmentation, of sound concrete 1b due to the impact of fragmentation, thereby causing further advancement of deterioration.

With the HM method, deteriorated un-fragmentized portions 1d are left under the steel bars 2a, 2b as shown in FIG. 12 so that it is difficult to remove them. Also, with this method, sound concrete 1b is fragmentized in the same way as unsound concrete 1a. Hence, in order to remove all unsound concrete 1a, sound concrete 1b is also fragmentized for placing repair concrete, and thus, the method is unreasonable and inefficient.

Moreover, with the HM method, since concrete composition is finely fragmentized with a small amount of water, pulverized concrete is mixed with waste water, producing highly alkaline pollutant water, and the cement slurry adheres to the steel bars. Therefore, there is the problem that extra work is required to neutralize the waste water and to remove the cement slurry.

### SUMMARY OF THE INVENTION

The present invention was made in view of the above-mentioned problems, and an object thereof is to present a method of fragmentizing a surface layer of concrete to remove deteriorated concrete by minimum fragmentation without causing unnecessary damage to the concrete structure.

Another object of the present invention is to present a method of fragmentizing a surface layer of concrete which can reduce waste water treatment, and simplify post-treatment after fragmentation.

Yet another object of the present invention is to present a method of fragmentizing a surface layer of concrete which, particularly in a reinforced concrete structure, can easily remove deteriorated concrete under steel bars without causing any damage to the steel bars.

Still another object of the present invention is to present a method of fragmentizing a surface layer of concrete which enables reliable and economical repair of concrete structures with achieving the above objects.

Yet another object of the present invention is to provide an apparatus for fragmentizing a surface layer of concrete which is suitable for applying the above described methods of fragmentizing a surface layer of concrete to.

In order to solve any of the above problems, according to one aspect of the present invention, there is provided a concrete surface layer fragmentizing method of fragmentizing a surface layer of a concrete structure by a jet formed by ejecting high pressure water from a nozzle, the method comprising adjusting control parameters for controlling the ejection and movement of the jet, including a fragmentation width, a standoff distance, ejection water pressure, ejection water amount, nozzle lateral movement speed, and the number of nozzle swing times; and sweeping the jet over a predetermined range so as to fragmentize only deteriorated concrete deteriorated in strength with leaving sound concrete (selective excavation, see FIG. 10).

Accordingly, only deteriorated concrete in concrete structures is fragmentized without causing unnecessary damage such as micro-cracks to the sound concrete portion, and thereby the deteriorated portions can be removed with minimum fragmentation.

In this description, the nozzle lateral movement means that the nozzle, while continuing some form of movement such as rotation and swing, is moved laterally substantially parallel to the to-be-fragmentized surface.

The fragmentation width is a width of fragmentation as seen in the direction of the nozzle lateral movement.

The standoff distance is a distance between the nozzle and the to-be-fragmentized surface.

The number of nozzle swing times is the number of times the nozzle is swung per unit time when it is moved so that the water jet is swung across the fragmentation width on the to-be-fragmentized surface. The number of nozzle swing times gives the average movement velocity of the water jet on its movement trajectory when the fragmentation width is decided.

According to another aspect of the present invention, in the above concrete surface layer fragmentizing method, the control parameters are set, in combination, to values in the respective following ranges: the fragmentation width=2 to 10 cm; the standoff distance=1 to 5 cm; the ejection water pressure=60 to 120 MPa; the ejection water amount=80 to 200 liter/min; the nozzle lateral movement speed=2 to 4 m/min; the number of nozzle swing times=120 to 240 round trips/min.

The parameter values in these ranges are substantially appropriate for usual deteriorated concrete.

According to yet another aspect of the present invention, in the above concrete surface layer fragmentizing method, with being tilted with respect to a normal line to a to-be-fragmentized surface, the jet is moved back and forth (swung) along a first direction, longitudinally, on the to-be-fragmentized surface, while the jet is moved back and forth along a second direction perpendicular to the first direction, laterally, so as to sweep the jet to fragmentize.

Hence, the water jet is incident at an angle to the to-be-fragmentized surface along the direction of the lateral movement, and thereby when there is an obstacle to fragmentation such as a steel bar, it can fragmentize deteriorated concrete under the steel bar obliquely. Further, the periphery of the water jet having strong digging action can be applied obliquely to the coarse aggregates of the concrete.

According to still another aspect of the present invention, in the foregoing concrete surface layer fragmentizing method, when the concrete structure is a reinforced concrete structure, with the first direction set to match the direction in which any of reinforcing bars thereof extends, the jet is swung, and the tilt direction of the jet with respect to a normal line to the to-be-fragmentized surface is reversed between back and forth in the lateral movement along the second direction.

Hence, the water jet is ejected to steel bars at an angle opposite between back and forth, and thus can be ejected certainly to the back side of the steel bars.

According to still another aspect of the present invention, in the above concrete surface layer fragmentizing method, the nozzle is a circular nozzle having a tubular orifice at the narrowing end of a conical cavity thereof (FIG. 4).

Hence, a water jet less in spread can be stably formed and thus, stable fragmentation force can be obtained.

According to yet another aspect of the present invention, there is provided a concrete surface layer fragmentizing apparatus which fragmentizes a surface layer of a concrete structure by a jet formed by ejecting high pressure water from a nozzle, wherein control parameters for controlling the ejection and movement of the jet can be set, in combination, to values in the respective following ranges: the fragmentation width=2 to 10 cm; the standoff distance=1 to 5 cm; the ejection water pressure=60 to 120 MPa; the ejection water amount=80 to 200 liter/min; the nozzle lateral movement speed=2 to 4 m/min; the number of nozzle swing times=120 to 240 round trips/min.

Thus, this concrete surface layer fragmentizing apparatus is suitable for implementing the concrete surface layer fragmentizing method of the present invention.

According to still another aspect of the present invention, there is provided a concrete surface layer fragmentizing apparatus which fragmentizes a surface layer of a concrete structure by a jet formed by ejecting high pressure water from a nozzle, the fragmentizing apparatus comprising a tilt section that tilts the nozzle with respect to a to-be-fragmentized surface; a back-forth movement section that moves the nozzle in a plane tilted by the tilt section so as to move the jet back and forth along a predetermined direction; and a lateral movement section that moves the nozzle, laterally, along a direction perpendicular to the predetermined direction.

Thus, this concrete surface layer fragmentizing apparatus is suitable for implementing the concrete surface layer fragmentizing method of the present invention.

According to yet another aspect of the present invention, the foregoing concrete surface layer fragmentizing apparatus further comprises a tilt angle change section that can control the tilt angle of the nozzle due to the tilt section so as to vary.

Hence, the tilt of the jet can be changed, and thus, the apparatus is flexible in dealing with various shapes of to-be-fragmentized surfaces.

According to still another aspect of the present invention, in the foregoing concrete surface layer fragmentizing apparatus, the nozzle is moved back and forth along the lateral movement direction and the tilt direction is reversed between back and forth by use of the tilt angle change section.

Thus, this concrete surface layer fragmentizing apparatus is suitable for implementing the concrete surface layer fragmentizing method of the present invention.

### BRIEF DESCRIPTION OF THE DRAWINGS

The above and other objects, features and other advantages of the present invention will be more clearly understood from the following detailed description of the preferred embodiments, taken in conjunction with the accompanying drawings, in which:

FIG. 1 is a diagram showing an embodiment of a concrete surface layer fragmentizing apparatus in accordance with the present invention;

FIG. 2 is a conceptual diagram of a simplified version of the apparatus of FIG. 1;

FIG. 3a is an enlarged view as seen in the visual direction E of FIG. 1, and FIG. 3b is a detailed cross sectional view taken along line C-C of FIG. 1;

FIG. 4 is a cross sectional view of an example of a nozzle used for the concrete surface layer fragmentizing apparatus according to the present invention;

FIGS. 5a and 5b are explanatory views for explaining the structure of a jet ejected into the air;

FIG. 6 is a graph showing a result of an experiment that indicates a relationship between the structure of the jet and destruction action thereof;

FIG. 7 is a graph showing a result of an experiment that indicates a relationship between the structure of the jet and a concrete fragmentation depth;

FIGS. 8a and 8b are conceptual diagrams of a concrete surface layer fragmentizing method using a swing scheme according to the present invention;

FIGS. 9a and 9b are a perspective view and a cross-sectional view respectively for explaining an embodiment of the concrete surface layer fragmentizing method according to the present invention;

FIG. 10 is a view for explaining ideal selective excavation according to the present invention;

FIG. 11a and 11b are a cross-sectional view for explaining a deteriorated-to-an-advanced-degree concrete structure and a cross-sectional view showing an example of conventional repair respectively; and

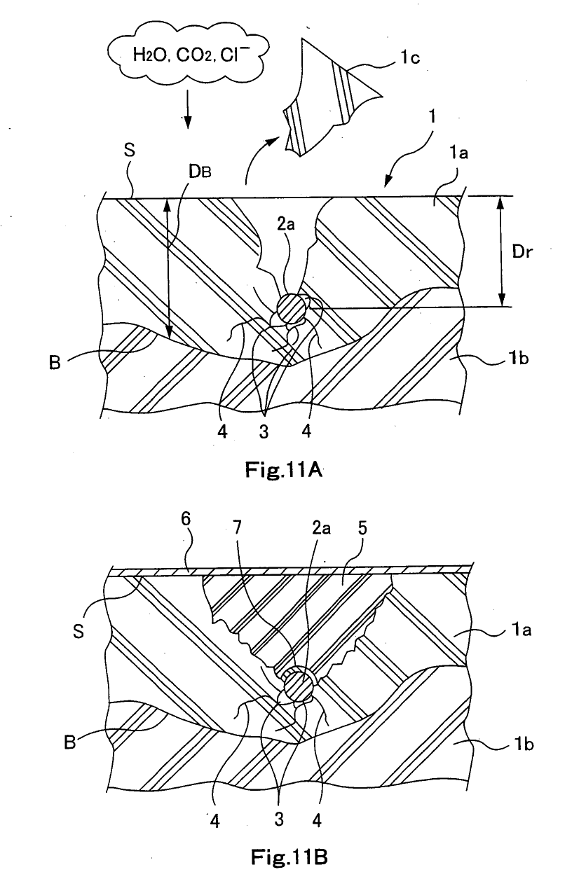

FIG. 12 is a cross-sectional view for explaining an exemplary conventional concrete fragmentizing method.

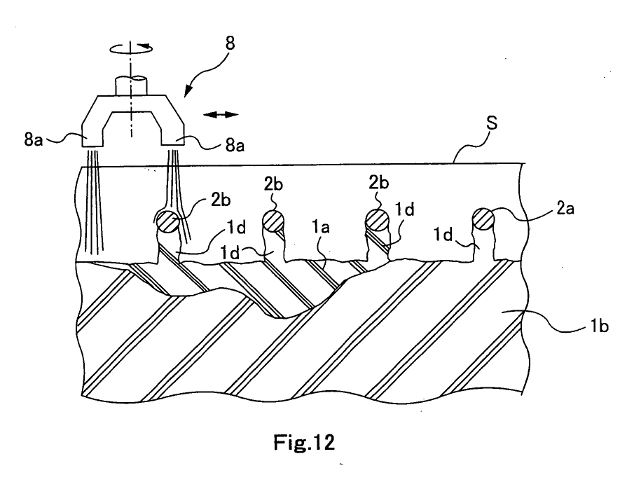

### DESCRIPTION OF THE PREFERRED EMBODIMENTS

Preferred embodiments in accordance with the present invention will be described below in detail with reference to the accompanying drawings. The same reference numerals indicate the same or corresponding parts throughout the drawings.

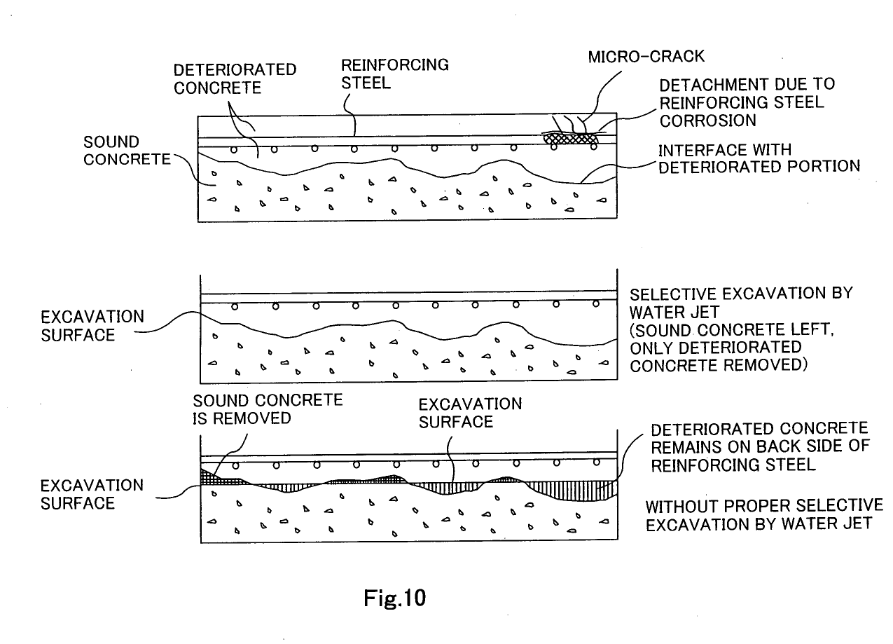

A concrete surface layer fragmentizing method and apparatus in accordance with the present invention, in the surface layer fragmentizing practice of removing deteriorated concrete before repair of a concrete structure, enables fragmentizing selectively only deteriorated concrete, which practically cannot be achieved by conventional methods such as the breaker or WJ method (see FIG. 10).

First, a concrete surface layer fragmentizing apparatus in accordance with the present invention will be described. The apparatus is an appropriate apparatus for implementing a concrete surface layer fragmentizing method in accordance with the present invention described later.

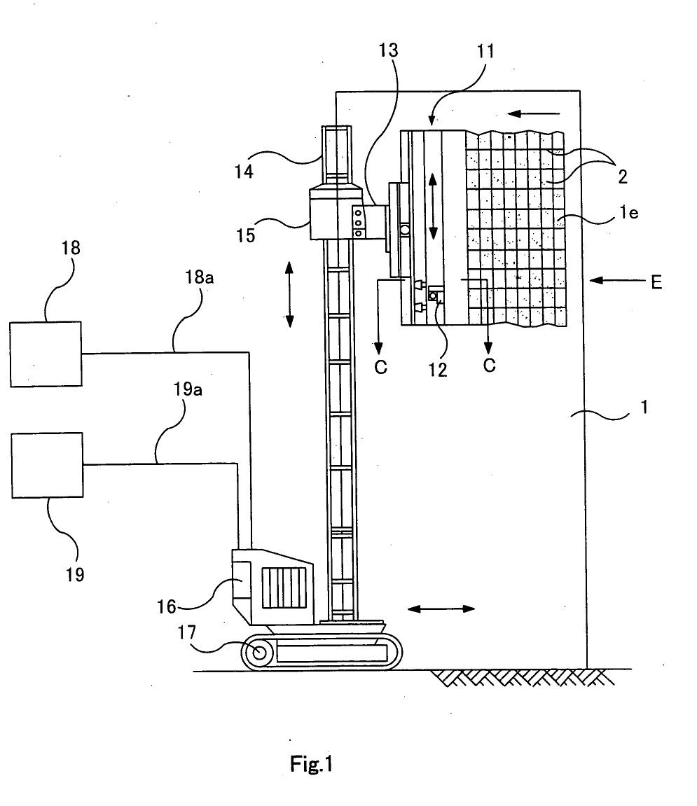

FIG. 1 is a schematic view of the concrete surface layer fragmentizing apparatus in accordance with the present invention, which is in the process of performing surface layer fragmentation on a wall surface of a concrete structure 1 in the form of a square column extending vertically. The base of the apparatus is a moving vehicle 17 with a self-propelled mechanism which is movable horizontally. A water jet control section 16 and a slide rail 14 vertically extending are mounted on the movable vehicle 17. The water jet control section 16 includes a high pressure water generating unit which pressurizes water fed through a supply hose 19a from an externally disposed water supply source 19, a power supply, a hydraulic control section and the like. A slider 15 is provided on the slide rail 14 so as to be slidable vertically along the slide rail 14, and an attitude change joint 13 is mounted on a side of the slider so as to be movable in a direction (perpendicular to the plane of the drawing) and also to be freely changeable in three axis angles. Provided at an end of the attitude change joint 13 is a holding frame 11 movably holding a nozzle moving section 12 with a jet nozzle (not shown).

The reference numeral indicates a control panel 18 provided with an input device such as a numeric keypad, a keyboard, switches, and dial, and a display device such as an LCD and meters (none shown), and control parameters (described later) for setting conditions for the overall behavior of the apparatus and the jet are remotely input through the console unit. The control panel 18 and the water jet control section 16 are electrically connected via a control cable 18a. The water jet control section 16 receives input signals from the control panel 18, and generates corresponding control signals.

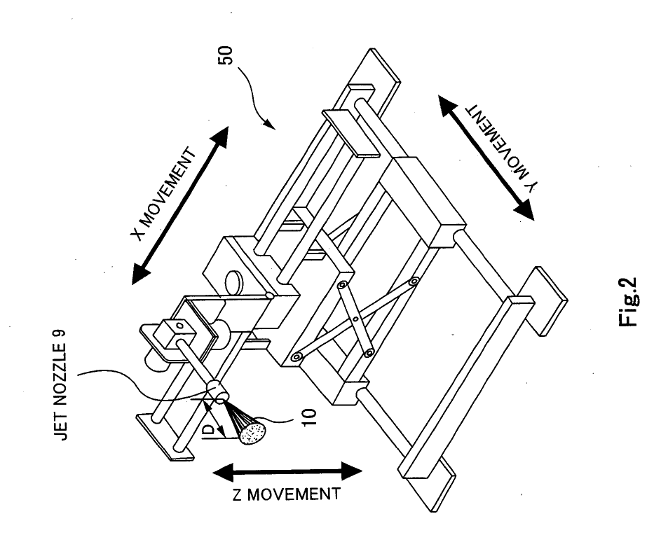

The reference numeral 1e indicates a newly exposed fragmentation-formed surface after the apparatus has fragmentized the surface layer of the concrete structure 1. The reference numeral 2 indicates the steel bars of the concrete structure 1. Furthermore, FIG. 2 shows a simplified version of the apparatus of FIG. 1. A nozzle 9 ejecting the water jet 10 is mounted on the nozzle moving section 50 movable in three axis directions.

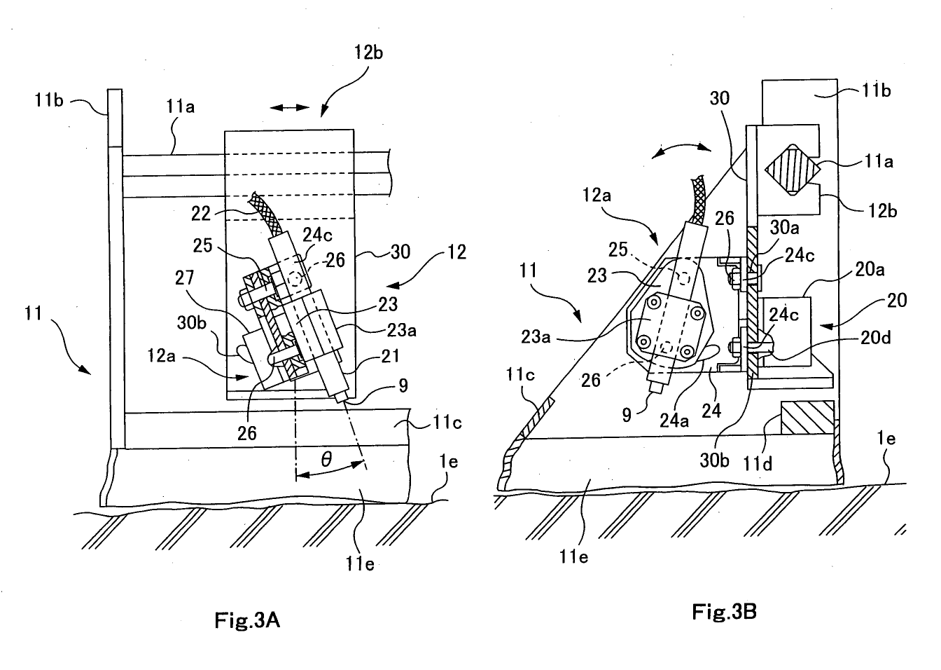

Referring now to FIG. 3, a description will be given of the holding frame 11 and the nozzle moving section 12. FIG. 3a is an enlarged view of the nozzle moving section 12 as seen in the visual direction E of FIG. 1. FIG. 3b is a side cross sectional view thereof taken along line C-C of FIG. 1. FIGS. 3A and 3B are drawn such that the fragmentation-formed surface 1e is put on the lower side of the figure. For the sake of convenience, in the explanation with reference to FIGS. 3A and 3B, “up and down direction” is used to means the up and down direction in the figure.

The holding frame 11 comprises two frame side plates 11b in the form of a substantially right triangle which are joined at three corners of the triangle by spanning members of equal length so as to form a triangular prism-like frame structure. A frame strut 11d made of section steel, steel pipe or the like is provided as a spanning member joining the right angle corners of the frame side plates 11b. The frame strut 11d is affixed at its longitudinal center to the attitude change joint 13. A guide rail 11a with longitudinally extending upper and lower surfaces is provided as a spanning member joining the hypotenuse upper corners of the frame side plates 11b, and a frame cover 11c made of sheet steel or the like is provided as a spanning member joining the lower corners of the frame side plates 11b. The frame cover 11c extends substantially along the slope of the hypotenuse of the holding frame 11, covering partially it.

Therefore, the frame-like opening surrounded by the frame cover 11c, frame strut 11d and frame side plates 11b faces the fragmentation-formed surface 1e shown on the lower side of the figure. At the perimeter of the opening, there is provided a shielding cover 11e, made of synthetic rubber or the like, extending outward for preventing water splashes and concrete rubble from flying in directions so as to form an outer fringe.

Next, a description will be given of the nozzle moving section 12.

The nozzle moving section 12 comprises a nozzle lateral moving section 12b (lateral movement section) provided on a plate-like carriage 30 parallel to the guide rail 11a and perpendicular to the fragmentation-formed surface 1e for having the plate-like carriage 30 move along the guide rail 11a, a nozzle swinging section 12a holding and swinging the nozzle 10, and a tilt angle change section 20 to secure the nozzle swinging section 12a to the carriage 30 at an angle with respect to the fragmentation-formed surface 1e.

The nozzle lateral moving section 12b, provided on an upper portion of a side surface of the carriage 30, movably engages with the guide rail 11a, for example, from above and below, and can adopt a scheme where a guide roller, a drive roller, and a drive motor are combined as needed (none shown).

The tilt angle change section 20 comprises a bracket 24 supporting the nozzle swinging section 12a (back-forth movement section) upright on the carriage 30 and being mounted thereon pivotably about a slide pin 26, and a pivot mechanism 20a for pivoting the bracket 24.

The bracket 24 is attached upright to the opposite side surface of the carriage 30 from the nozzle lateral moving section 12b by upper and lower mounting members 24c. The upper mounting member 24c is pivotably attached by the slide pin 26. The lower mounting member 24c is attached to a slide shaft 20d which extends from the pivot mechanism 20a and engages with an arc-shaped tilt guide 30b (see FIG. 3a), the arc having the slide pin 26 provided on the carriage 30 as its center.

Further, provided on the upright surface of the bracket 24 are a pin 25 by which the nozzle swinging section 12a is pivotably attached, and an arc-shaped slide guide 24a (see FIG. 3b), the arc having the pin 25 as its center.

The pivot mechanism 20a, which comprises, for example, a hydraulic motor, can rotate through a given angle according to the control signal and hold that rotation angle. Let the vertical direction be at 0 degrees, the rotation angle can be set at any angle in the range of, for example, ±30 degrees.

The nozzle swinging section 12a comprises a nozzle support plate 23 rotatably mounted on the bracket 24, and a nozzle holder 21 secured on the nozzle support plate 23 by means of a holder 23a. A nozzle 9 is provided at the lower end of the nozzle holder 21, and a hose 22 is connected to the upper end thereof to feed high pressure water.

The pin 25 extending from the nozzle support plate 23 engages pivotably with the bracket 24, and the slide pin 26 extending from the nozzle support plate 23 is inserted into the slide guide 24a, so that the nozzle support plate 23 is pivotably attached to the bracket 24. Affixed to the rear face of the bracket 24 is a swing mechanism 27 for moving the slide pin 26 along the slide guide 24a. The swing mechanism 27 comprising, for example, a hydraulic motor can rotate bidirectionally at high speed.

Note that both the pivot mechanism 20a and the swing mechanism 27 are connected to the water jet control section 16 by a control signal line (not shown), and configured to be controlled according to input through the control panel 18.

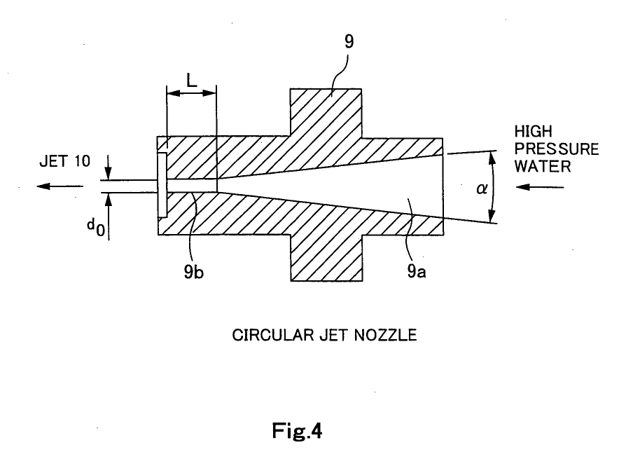

Next, an example of the structure of the nozzle 9 will be described with reference to FIG. 4. FIG. 4 is a cross sectional view showing an axial cross section of the nozzle 9, which is a rotationally symmetrical tubular member. The nozzle 9 is provided with a conical surface 9a open to upstream and having a vertex angle forming an angle α in the axial cross section for narrowing down the waterway for high pressure water, and a tubular orifice 9b of length L and diameter d₀ downstream of the conical surface.

The conical surface 9a is finished to have highly precise surface roughness for suppressing turbulence in the high pressure water jet and has a low gradient with small form error. Further, the orifice 9b is smoothly joined to the conical surface 9a.

The ratio L/d₀ of the orifice length L to the orifice diameter d₀ is at least 3. For the most preferable nozzle shape, the ratio L/d₀ is about 4, and the vertex angle α of the cone is about 13°. It is desirable that the vertex angle α be small, and if the ratio L/d₀ is taken to be less than 4, it is desirable that the vertex angle α be no more than 13°.

Next, a description will be given of a concrete surface layer fragmentizing method in accordance with the present invention. The present method, although using the WJ method, is an innovative method which fragmentizes only deteriorated concrete within a predetermined range by adjusting water jet control parameters so as to utilize the characteristics of the water jet that have never been utilized, and also is a method which can efficiently fragmentize deteriorated concrete in a deep range including the back side of steel bars (see FIG. 10).

In this connection, the present method starts with adjusting the water jet control parameters. First, a description will first be given of the characteristics of a jet, of which the present invention takes advantage.

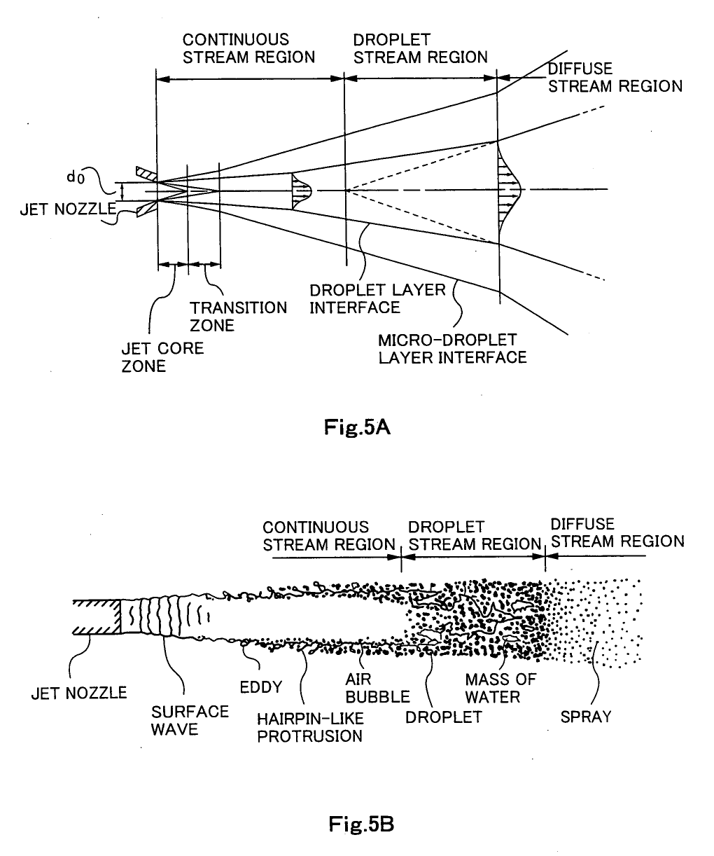

When a jet is ejected at high speed into the air, the high-speed water jet in the air exhibits a structure as shown in FIG. 5a (Yanaida, K., and Ohashi, A. Research on Characteristics of High-Speed Water Jet in the Air Concerning Atomized Droplet Region, the Second Report, Journal of the Mining Institute of Japan, 93-1073 (1977), 489). As shown in this drawing, the high-speed water jet in the air can be broadly classified into three regions: a continuous stream region where the water jet maintains continuity; a droplet stream region where the water jet loses the continuity to generate masses of water and droplets; and a diffuse stream region where the water jet breaks to get in a spray state and diffuses. In the continuous stream region particularly, a transparent portion containing no air which appears in the vicinity of a jet nozzle is called a jet core zone. As the water jet goes downstream, the transparent portion undergoes a transition zone, where air enters the water jet from the periphery thereof, and disappears in the end.

More specifically, as shown in FIG. 5b, a stream of water discharged from the nozzle has a smooth liquid interface immediately after discharged, but surface waves soon appear. The amplitude of the surface waves become gradually larger as the surface waves go downstream. In a downstream portion of the surface waves, the interface is swirlingly drawn inside the water jet to generate unstable eddies. The swirls of crest portions of the surface waves which have become large before long cause protrusions in a hairpin shape to grow, and allow air to mix into the water jet, forming the disturbed interface containing a large number of air bubbles in the vicinity of the interface. In the droplet stream region located downstream of this, tip portions of the protrusions on the disturbed interface is broken off, becoming very small droplets. At the same time, the breakup gradually proceeds to a central portion of the water jet to cause the water jet to split into masses of water and droplets. These masses of water and droplets further repeat splitting up, and in the diffuse stream region located downstream of this, become fine spray in the end.

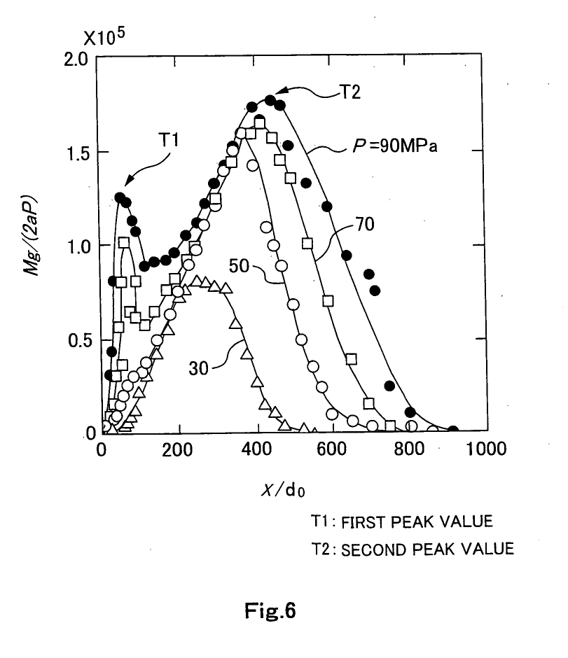

FIG. 6 shows results of experiment which have revealed a relationship between such a structure of a water jet and the breaking action of the water jet. This graph shows results of measuring a relationship that a reduced amount M in mass of a metal material caused by the hit of a high-pressure water jet varies with a distance X between a nozzle outlet and the subject material, in the case of aluminum (Kobayashi, R. Solid Material Processing with High-Speed Water Jet (State of the Art), The Japan Society of Mechanical Engineers Journal Series B, 52-483 (1986), 3645). The diameter of a nozzle outlet (orifice diameter) d is 1 mm, and discharging time is 60 seconds. The reference symbol a denotes the area of the nozzle outlet; g, the acceleration of gravity; and P, the ejection pressure measured upstream of the nozzle. In FIG. 6, the vertical axis represents a value nondimensionalized by dividing a reduced amount M in mass when the ejection pressure P is set to 30 MPa, 50 MPa, 70 MPa, or 90 MPa, by a value equivalent to a kinetic momentum (2aP) of the water jet. The horizontal axis represents a nondimentinal standoff distance, nondimensionalized by dividing a distance X by a nozzle outlet diameter d.

As can be seen from FIG. 6, when the ejection pressure P is 50 MPa or higher, the reduced amount M in mass hits a first peak T₁ in the vicinity of the nozzle and hits a second peak T₂, which is the maximum, at a position away from the nozzle depending on each of the ejection pressures (in the graph, T₂ indicates the second peak when P=90 MPa). It is generally thought that the digging action of the water jet is predominant in the vicinity of the first peak and the impact breakage due to the hit of masses of water and droplets is predominant in the vicinity of the second peak. Further, it is known from the dug patterns of the aluminum plates used in the experiment that the digging action of the water jet is dominant at the periphery of the water jet.

Meanwhile, concrete, which is made by combining fine aggregates such as sand and coarse aggregates having high compressive strength such as gravel with cement matrix, is a complex material with brittleness and water permeability. Therefore, in order to apply the result of the above-described digging experiment to the fragmentation of concrete, it is necessary to consider the physical structure of a water jet and the characteristics of the concrete composition which are different from those of metal. The inventor holds that since there are more voids in deteriorated concrete, by fragmentizing and removing only the cement matrix in the deteriorated portions without going so far as to break the coarse aggregates, the concrete composition becomes dissected and thus, concrete having lost integrity must be able to be fragmentized.

Thus, the inventor has reached the present invention wherein while in order to utilize the digging action, the standoff distance is set at a distance corresponding to the vicinity of the first peak T₁ (relatively short from the nozzle) for the digging action, relatively low pressure water is used so as not to break the coarse aggregates, thereby making a great deal of water permeate into the concrete.

Incidentally, concrete fragmentation according to the conventional WJ method uses a standoff distance close to zero, i.e. adjacent to the nozzle, rather than a distance corresponding to the vicinity of the first peak T₁ and ultra high pressure small-amount water like the HM method, and fragmentizes and cuts concrete including coarse aggregate from the surface by using the strong digging action zone. Thus, there has not been a technical idea that takes advantage of deterioration of concrete composition itself such as that of cement matrix to efficiently fragmentize.

The appropriate control parameters in the concrete surface layer fragmentizing method and apparatus of the present invention for fragmentizing deteriorated concrete of a usual concrete structure, according to overall results of the experiments conducted by the inventor, are as follows: the standoff distance=1 to 5 cm; the ejection water pressure P=60 to 120 MPa; and the ejection water amount Q=80 to 200 litter/min. Experience shows that conducting an experiment in which to fragmentize deteriorated concrete samples with varying the values of the control parameters within their respective ranges can efficiently determine the condition for fragmentizing only deteriorated concrete with leaving sound concrete.

Note that it goes without saying that for concrete of high strength, old concrete structures such as historical architectures, or concrete structures extremely deteriorated because of, for example, alkaline aggregate reaction, appropriate control parameter values are expected to be outside the ranges described above, and thus parameter values outside the above ranges can also be adopted.

The nozzle orifice diameter d is determined from the ejection water pressure P and ejection water amount Q required for fragmentation. If the well-known Bernoulli equation is used, the ejection water amount Q can be determined by simple calculation using the orifice diameter d and the ejection water pressure P as follows. Here, note that F is nozzle efficiency according to the shape of the jet nozzle.
Q=d²×\sqrt{P}×0.659×F
where Q is the ejection water amount (l/min), P is the ejection water pressure (bar), F is the nozzle efficiency (0.92 to 0.95), and d is the orifice diameter (mm).

For example, when F=0.95, the orifice diameter d satisfying the above ranges is calculated to be about 1.9 to 3.6 mm.

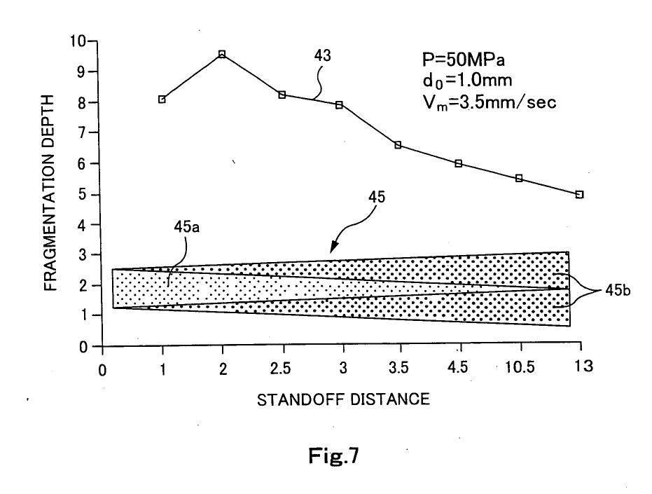

The following is the reason why the standoff distance range is determined as above. FIG. 7 shows an example of the result of an experiment indicating a relationship between the standoff distance and the fragmentation depth. The experiment was conducted in the following condition: ejection pressure P=50 MPa; orifice diameter d₀=1.0 mm; and nozzle movement velocity Vₘ=3.5 mm/sec. The abscissa (partially uneven scale) represents the standoff distance, and the ordinate represents the fragmentation depth, the experimental result graph being represented by a kinked line 43. For better understanding, the water jet structure corresponding to this standoff distance range is shown as a schematic diagram 45 for comparison (reference numeral 45a denoting the jet core, reference numeral 45b denoting the air-intruded-in part other than the jet core reduced by the intrusion of air). Referring to FIG. 6, in the above conditions, the standoff distance that gives the first peak T₁ is about 8 cm.

The kinked line 43 gradually rises from standoff distance=1 cm, peaks at standoff distance=2 cm, and declines at an almost uniform rate up to standoff distance=about 5 cm and moderately from there on, the line being like a mountain. This indicates that the concrete fragmentation depth (fragmentation amount) has no direct relationship with the first peak T₁ of the experiment of FIG. 6, and is maximal at a point slightly downstream of the jet core zone. The graph also indicates that significant fragmentation cannot be hoped for when the standoff distance is 5 cm or longer.

The reason for that is considered to be that concrete fragmentation is caused by a principle other than the digging action of water cutting concrete. The big difference between deteriorated concrete and sound concrete is whether faults such as a pore structure or cracks enlarged by the advancement of carbonation (neutralization) exist making concrete brittle. In deteriorated concrete, because water easily permeates through such fine cracks, when water pressure is continually applied to the surface, the water pressure is transmitted to the inside via water having permeated (dynamic pressure), thereby producing a wedge effect that tensile stress to open the crack is generated at the tip of the crack which advances the cracks and thus breakage. Furthermore, because the jet having digging action not enough to fragmentize coarse aggregates but enough to fragmentize deteriorated concrete hits the concrete surface, deteriorated cement compositions around the coarse aggregates are removed by digging, and the jet arrives deeper allowing permeation of water further into the inside, thereby terminating the integrity of the structure of the coarse aggregates and cement with the wedge effect and breaking the concrete into pieces. It is thought that the selective destruction as above occurs and advances on the surface of and inside the concrete as if the water searched for faults in the concrete.

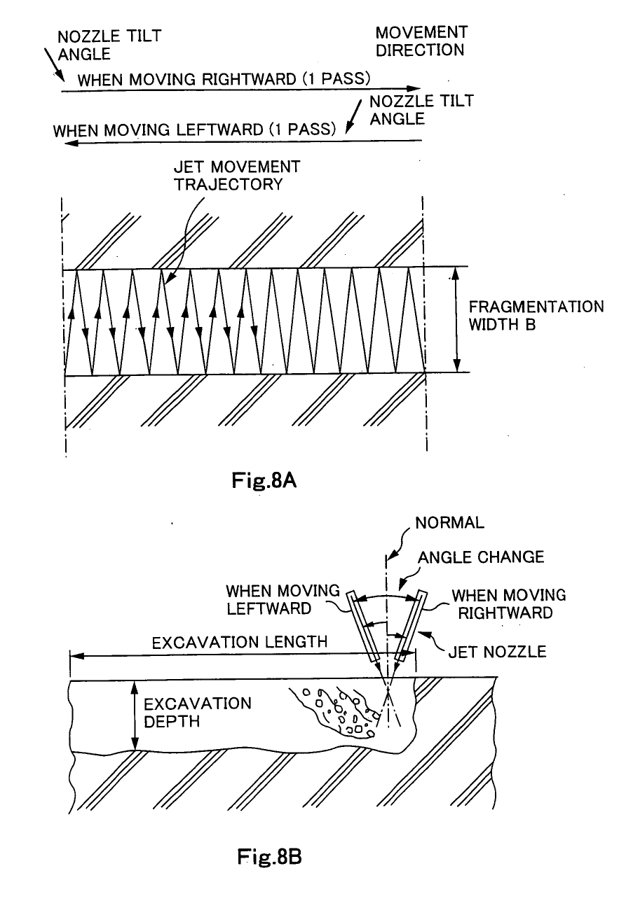

Next, a description will be given of an embodiment of the concrete surface layer fragmentation according to the present invention. FIG. 8 shows a conceptual view of the fragmentizing method using a nozzle swing scheme. FIG. 8a and FIG. 8b are a plan view and a cross-sectional view thereof respectively. The outline of the fragmentizing method using the nozzle swing scheme will be explained.

As shown in FIG. 8a, the jet nozzle is swung such that the jet moves back and forth across a fragmentation width b forming a zigzag jet movement trajectory, while being moved laterally back and forth in the figure (lateral movement). This leg is called a pass herein. When moved to the right, as shown in FIG. 8b, the nozzle is tilted to the left, and after one rightward pass, moved back to the left. When moved to the left for a leftward pass, as shown in FIG. 8b, the nozzle is tilted to the right. By repeating such passes, a required excavation depth is obtained.

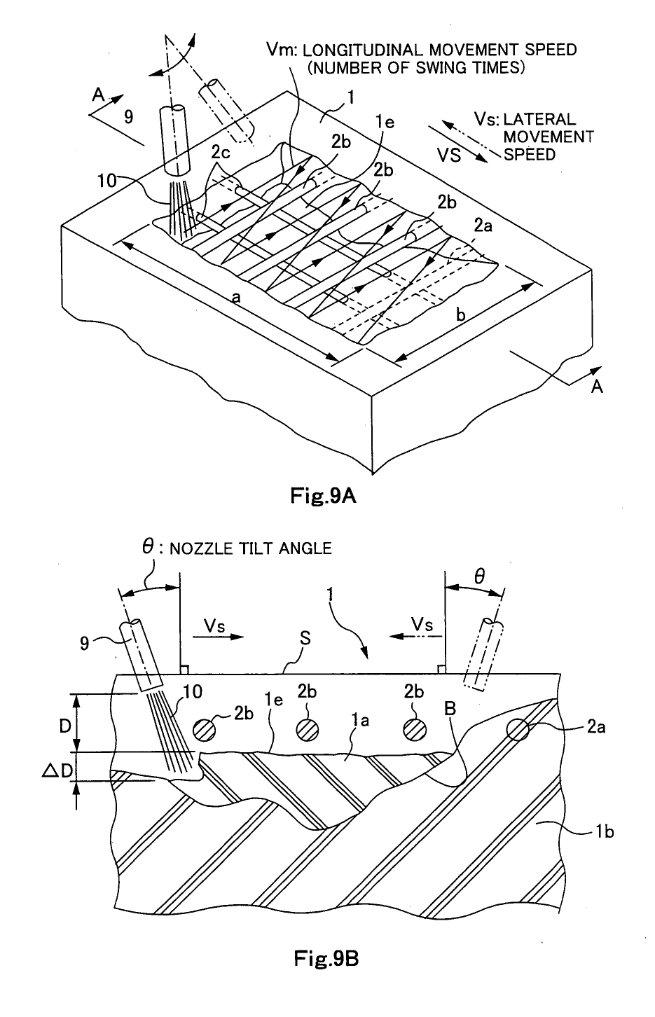

Next, with reference to FIG. 9, the concrete surface layer fragmentizing method according to the present invention will be explained. FIG. 9a is a perspective view for explaining an embodiment of the concrete surface layer fragmentizing method of the present invention, and FIG. 9b is a cross-sectional view on line A-A of FIG. 9a.

In a concrete structure 1, reinforcing steel bars 2a, 2b are embedded parallel to each other at predetermined intervals and beneath and perpendicular to them are embedded reinforcing steel bars 2c parallel to each other. On the upper side of an interface B is deteriorated concrete 1a and on the lower side thereof is sound concrete 1b.

The nozzle 9 for fragmentizing is supported by the nozzle swinging section (not shown) at an angle of θ with respect to a normal line to the surface S of the concrete structure 1, and swung in the same direction as the steel bars 2a, 2b extend so that the water jet 10 moves back and forth across the fragmentation width b at longitudinal movement speed Vₘ (the number of swing times). Also, the nozzle swinging section is moved perpendicular to the direction in which the steel bars 2a extends at lateral movement speed Vₛ (lateral movement), and after traveling length a, is controlled to move back.

The nozzle 9 is standoff distance D apart in the depth direction from the to-be-fragmentized surface 1e before the start of fragmentation. The control parameters are adjusted beforehand such that the deteriorated concrete 1a is fragmentized approximately up to a constant depth ΔD with a single lateral pass. The nozzle 9 is moved back and forth a plurality of times (the number of pass times). At the end of each pass, the tilt angle of the nozzle 9 is reversed by the tilt angle change section (not shown). In this manner, the water jet 10 travels the fragmentation width b back and forth while traveling the distance a back and forth so as to draw a zigzag trajectory on the to-be-fragmentized surface 1e thereby fragmentizing only the deteriorated concrete and exposing the steel bars 2b and the surface of the sound concrete 1b.

In order to fragmentize by ΔD with a single lateral pass, the control parameters are determined through a preliminary experiment using a sample of a concrete structure 1 subject to fragmentation. In the general procedure, the ejection water pressure and ejection water amount are determined with the standoff distance D and the fragmentation width b being fixed. Tests are conducted with varying the lateral movement speed Vₛ. If no optimum value is found, tests are again conducted with varying the ejection water pressure and ejection water amount. If an optimum value is still not found, tests are again conducted with varying the number of swing times, the longitudinal movement speed Vₘ, and/or the standoff distance D. The parameters are more efficiently determined by keeping the standoff distance D fixed, if possible.

Generally, the lower the longitudinal movement speed Vₘ or the lateral movement speed Vₛ become, the greater the fragmentation force becomes, thereby resulting in deeper fragmentation. Furthermore, as the speed becomes higher, the fragmentation depth becomes shallower, which can be, however, increased by increasing the number of the lateral movements (the number of passes). Consequently, target values are chosen in view of, for example, efficiency in construction. For example, at the fragmentation width b=4 cm, the longitudinal movement speed Vₘ=9.6 to 19.2 m/min (120 to 240 round trips per minute) and the lateral movement speed Vₛ=about 2 to 4 m/min proved appropriate.

Note that while the jet 10 permeates through a relatively large pore structure and cracks exposed on the surface of deteriorated concrete 1a thereby advancing fragmentation, where sound concrete 1b having no such defects on the surface is exposed, fragmentation does not advance therein, but a little encroachment may occur on the surface. Hence, the ΔD refers to the fragmentation depth of deteriorated concrete, and sound concrete is not fragmentized regardless of the value of ΔD. If, as shown in FIG. 9b, the depth of the deteriorated concrete 1a varies from place to place, fragmentation exposes the interface B, the outermost surface of sound concrete 1b, in which case the exposed area can be excluded from the next sweeping for operating efficiency.

Further, since the nozzle 9 is held at an angle θ with respect to a normal line to the to-be-fragmentized surface 1e, the jet 10 can reach and fragmentize deteriorated concrete 1a on the back side of the steel bars 2b. Furthermore, because during the back and forth in the lateral movement direction of the nozzle 9, the tilt direction of the nozzle is reversed, un-fragmentized deteriorated concrete left when on a forth pass can be fragmentized when on the back pass, and thus un-fragmentized deteriorated concrete is not left on the back side of the steel bars 2b. The greater the tilt angle θ, the more likely the water jet is to reach the back side, but a greater tilt angle reduces fragmentation force. The tilt angle can be determined with balancing the two factors according to the need. Usually, a tilt angle of about 15° produces a sufficient effect, and for steel bars of larger diameters, a greater tilt angle of, for example, about 25° is appropriate.

Additionally, for the purpose of leaving no un-fragmentized concrete on the back side of the steel bars 2b, the tilt angle θ need not be exactly the same in degree when reversed. Only a change in the orientation of the nozzle suffices as long as the angle is within a preferable range of degree. Note, however, that if the nozzle is turned such that the tilt angle is the same in degree, fragmentation force and thus fragmentation depth are substantially the same between the back and forth passes, which is more desirable.

Further, since the nozzle 9 can be tilted at any desired angle, the tilt angle θ may be set at 0° to orient the nozzle substantially perpendicular to the to-be-fragmentized surface. Further, for curved surfaces of cylindrical concrete pillars, girders, etc., by changing the tilt angle according to the curvature of the to-be-fragmentized surface, the advantage that the surface can be fragmentized with uniform fragmentation force is obtained.

According to the present method, when used with the concrete surface layer fragmentizing apparatus of the present invention, practice can be performed efficiently. A description of the operation thereof will be given below. Let it be that all the control parameter values for the jet and the like are input appropriately beforehand via the control panel 18 (see FIG. 1).

As shown in FIGS. 3A and 3B, the swing mechanism 27 of the nozzle swinging section 12a is rotated bi-directionally at a predetermined frequency at a predetermined amplitude so that the nozzle support plate 23 is swung about the pin 25 along the arrow direction (see FIG. 3b). Consequently, the nozzle holder 21 secured on the nozzle support plate 23 swings, and the water jet 10 ejected from the nozzle 9 at the end thereof is also swung.

The swing angle range is decided by the amplitude of the bi-directional rotation of the swing mechanism 27. The fragmentation width b is easily calculated from the height of the pin 25 relative to the to-be-fragmentized surface 1e. The swing speed can be adjusted by varying the frequency of the bi-directional rotation of the swing mechanism 27.

The nozzle swinging section 12a, joined with the tilt angle change section 20, is rotatable about the slide pin 26. The rotation of the pivot mechanism 20a causes the bracket 24 to rotate on the carriage 30 so that the tilt angle θ of the swing plane of the nozzle 9 can be varied. Since being varied by the rotation of the pivot mechanism 20a, the tilt angle θ can be set to any angle. For example, the tilt angle θ can be reversed from +25° to −25°, and can be held by stopping the rotation of the pivot mechanism 20a.

Since the swing direction is perpendicular to the guide rail 11a, setting the swing direction to match the direction in which the steel bars 2 extend can be done by moving the attitude change joint 13 so as to adjust the attitude of the holding frame 11.

By rotating bi-directionally the drive rollers 32a by means of the drive motor 32b, the nozzle lateral moving section 12b can be moved back and forth along the lower surface of the guide rail 11a and along the direction in which the guide rail 11a extends. Further, lowering the nozzle by ΔD can be done by lowering the entire holding frame 11 by means of the attitude change joint 13.

As seen from the above description, in the apparatus of the present invention, while the water jet 10 ejected from the nozzle 9 is moved back and forth along the swing direction on the to-be-fragmentized surface 1e, it is moved back and forth along a lateral direction perpendicular to the swing direction. Furthermore, as the to-be-fragmentized surface 1e goes down, the nozzle can be lowered so as to keep the standoff distance constant. By controlling the tilt angle change section 20, the tilt angle of the water jet can be set at any angle and reversed between the back and forth passes of the lateral movement.

Accordingly, by repeating moving back and forth the nozzle 9 with the position of the holding frame 11 fixed, fragmentation in a strip (a×b) as shown in FIG. 9a can be performed. Upon completion of the fragmentation of a given area, the holding frame 11 is moved by a combination of the movement of the slider 15 and the movement of the movable vehicle 17 to extend the fragmentized area or fragmentize another area.

As described above, with the present apparatus, the concrete surface layer fragmentizing method of the present invention can be repeatedly mechanically executed. Stable and highly reliable fragmentation can be performed.

Moreover, as described above, according to the concrete surface layer fragmentizing method of the present invention, deteriorated portions can be removed with minimum fragmentation and without causing unnecessary damage to the concrete structure. Also, for a reinforced concrete structure, deteriorated portions under reinforcing steel bars can be easily removed without causing damage to the steel bars. Thus, the concrete surface layer fragmentizing method enables highly reliable and economical repair of concrete structures.

Furthermore, in this method, broken concrete pieces are relatively large since coarse aggregates are not cut, and since a large amount of water is used, the increase in the pH of the waste water is so suppressed that it can be easily neutralized by the use of aluminum sulfate or the like. Thus, there is no need for a costly waste water neutralizing process.

Further, coarse aggregates in the rubble are undamaged and almost the same as if they had been processed by water washing, so that they are easy to reuse as coarse aggregates.

Further, unlike hit by a solid such as a breaker, the water jet 10 controlled in the parameters does not generates micro-cracks from the hit point and thus new faults in sound concrete 1b.

Moreover, by placing repair concrete on sound concrete 1b exposed by such fragmentation, highly reliable and enduring repair becomes possible because of union between identical sound concrete compositions and thus good compatibility.

Note that although there may remain un-fragmentized concrete on the back side of the steel bars 2c extending perpendicular to the swing direction of the nozzle 9 as above, in the case of thin steel bars, the un-fragmentized concrete is weak in strength and thus may be fragmentized during the repetition of the oblique ejection of the water jet 10. Accordingly, the swing direction of the nozzle 9 may be set to match the direction in which relatively thick main steel bars extend. If un-fragmentized concrete is still left, the swing direction and the direction of the lateral movement may be switched when having reached the depth of the steel bars 2c.

As described above, the tilt angle θ of the nozzle 9 is preferably reversed between the back and forth passes in terms of certainly removing un-fragmentized portions. However, if the tilt angle is not reversed, un-fragmentized portions may remain extending at the tilt angle θ and hence can be seen vertically from above. Thus, the un-fragmentized portions can be relatively easily fractured by, for example, a breaker, and thus there is seen a significant improvement in working efficiency over the case where the water jet is not tilted.

While the above description has been made by way of an example where the concrete structure 1 is a reinforced concrete structure, if it is not a reinforced concrete structure, there is no need for the longitudinal movements for not leaving un-fragmentized portions on the back side of the steel bars. Hence, needless to say, the jet 10 may be moved laterally while being rotated on the to-be-fragmentized surface.

While the present invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

1. A concrete surface layer fragmentizing method of fragmentizing a surface layer of a concrete structure by a jet formed by ejecting high pressure water from a nozzle, the method comprising:
adjusting control parameters for controlling the ejection and movement of said jet, including a fragmentation width, a standoff distance, ejection water pressure, ejection water amount, nozzle lateral movement speed, and the number of nozzle swing times; and
sweeping said jet over a predetermined range so as to fragmentize only deteriorated concrete deteriorated in strength with leaving sound concrete (selective excavation).

2. The concrete surface layer fragmentizing method according to claim 1, wherein said control parameters are set, in combination, to values in the respective following ranges:
the fragmentation width=2 to 10 cm;
the standoff distance=1 to 5 cm;
the ejection water pressure=60 to 120 MPa;
the ejection water amount=80 to 200 liter/min;
the nozzle lateral movement speed=2 to 4 m/min;
the number of nozzle swing times=120 to 240 round trips/min.

3. The concrete surface layer fragmentizing method according to claim 1, wherein with being tilted with respect to a normal line to a to-be-fragmentized surface, said jet is moved back and forth (swung) along a first direction, longitudinally, on the to-be-fragmentized surface, while said jet is moved back and forth along a second direction perpendicular to said first direction, laterally, so as to sweep said jet to fragmentize.

4. The concrete surface layer fragmentizing method according to claim 3, wherein, when said concrete structure is a reinforced concrete structure, with said first direction set to match the direction in which any of reinforcing bars thereof extends, said jet is swung, and the tilt direction of said jet with respect to a normal line to the to-be-fragmentized surface is reversed between back and forth in the lateral movement along said second direction.

5. The concrete surface layer fragmentizing method according to claim 1, wherein said nozzle is a circular nozzle having a tubular orifice at the narrowing end of a conical cavity thereof.

6. A concrete surface layer fragmentizing apparatus which fragmentizes a surface layer of a concrete structure by a jet formed by ejecting high pressure water from a nozzle, wherein control parameters for controlling the ejection and movement of said jet can be set, in combination, to values in the respective following ranges:
the fragmentation width=2 to 10 cm;
the standoff distance=1 to 5 cm;
the ejection water pressure=60 to 120 MPa;
the ejection water amount=80 to 200 liter/min;
the nozzle lateral movement speed=2 to 4 m/min;
the number of nozzle swing times=120 to 240 round trips/min.

7. A concrete surface layer fragmentizing apparatus which fragmentizes a surface layer of a concrete structure by a jet formed by ejecting high pressure water from a nozzle, said fragmentizing apparatus comprising:
a tilt section that tilts said nozzle with respect to a to-be-fragmentized surface;
a back-forth movement section that moves said nozzle in a plane tilted by said tilt section so as to move said jet back and forth along a predetermined direction; and
a lateral movement section that moves said nozzle, laterally, along a direction perpendicular to said predetermined direction.

8. The concrete surface layer fragmentizing apparatus according to claim 7, further comprising:
a tilt angle change section that can control the tilt angle of said nozzle due to said tilt section so as to vary.

9. The concrete surface layer fragmentizing apparatus according to claim 8, wherein said nozzle is moved back and forth along said lateral movement direction and the tilt direction is reversed between back and forth by use of said tilt angle change section.

10. The concrete surface layer fragmentizing method according to claim 2, wherein with being tilted with respect to a normal line to a to-be-fragmentized surface, said jet is moved back and forth (swung) along a first direction, longitudinally, on the to-be-fragmentized surface, while said jet is moved back and forth along a second direction perpendicular to said first direction, laterally, so as to sweep said jet to fragmentize.

11. The concrete surface layer fragmentizing method according to claim 2, wherein said nozzle is a circular nozzle having a tubular orifice at the narrowing end of a conical cavity thereof.

12. The concrete surface layer fragmentizing method according to claim 3, wherein said nozzle is a circular nozzle having a tubular orifice at the narrowing end of a conical cavity thereof.

13. The concrete surface layer fragmentizing method according to claim 4, wherein said nozzle is a circular nozzle having a tubular orifice at the narrowing end of a conical cavity thereof.

14. The concrete surface layer fragmentizing method according to claim 10, wherein said nozzle is a circular nozzle having a tubular orifice at the narrowing end of a conical cavity thereof.
